(19) United States
(12) Patent Application Publication
(10) Pub. No.: US 2024/0320569 A1
(43) Pub. Date: Sep. 26, 2024

(54) SEAT RESERVATION DEVICE, COMPUTER READABLE MEDIUM, SEAT RESERVATION METHOD, AND SEAT RESERVATION SYSTEM

(71) Applicant: Mitsubishi Electric Corporation, Tokyo (JP)

(72) Inventors: Yuhei ANDO, Tokyo (JP); Masahiro KIMURA, Tokyo (JP)

(73) Assignee: Mitsubishi Electric Corporation, Tokyo (JP)

(21) Appl. No.: 18/734,059

(22) Filed: Jun. 5, 2024

Related U.S. Application Data
(63) Continuation of application No. PCT/JP2022/002985, filed on Jan. 27, 2022.

(51) Int. Cl. G06Q 10/02

(52) U.S. Cl. CPC G06Q 10/02

(57) ABSTRACT

A seat reservation device (100) includes: a pattern extraction unit (103) to extract, from a consecutive-seating pattern candidate group (240A), a consecutive-seating pattern group, based on train reservation information (210) and train vehicle information (220); a reservation totaling unit (104) to total counts of suites per suite type having a same boarding section and a same same-time reservation people count, from the reservation information (210), and to generate total information (250); a problem generation unit (105) to generate an optimization problem (260) on seating layout of reservation passengers, which involves a decision variable not dependent on a reservation people count, a constraint condition, and an objective function, based on the vehicle information (220), an evaluation index, the consecutive-seating pattern group (240B), and the total information (250); a solution unit (106) to solve the optimization problem (260) and to decide the seating layout (270) of the reservation passengers.

### CROSS REFERENCE TO RELATED APPLICATIONS

This application is a Continuation of PCT International Application No. PCT/JP2022/002985, filed on Jan. 27, 2022, all of which is hereby expressly incorporated by reference into the present application.

### TECHNICAL FIELD

The present disclosure relates to a seat reservation device, a seat reservation program, a seat reservation method, and a seat reservation system.

### BACKGROUND ART

For transportation facility such as railways and express buses whose seats are reserved by passengers, a method of deciding a seating layout in a batch manner has been studied for a purpose of improving operator profits and passenger satisfaction. A reason of this study is that with a conventional method of deciding a seat each time the seat is reserved, an unfavorable seating layout is likely to result depending on subsequent reservations. The problem of unfavorable seating layout may be solved by batch-like decision making that decides a layout all at once after a certain amount of reservations are made.

In transportation facility such as railways and express buses in which a plurality of boarding sections exist, a count of possible seating layouts is enormous, so an appropriate seating layout is not evident.

Patent Literature 1 employs a means for deciding a seating layout in existing reservations in a batch-like manner using a mathematical optimization problem, under a condition that seats are not fixed until immediately before train departure. In Patent Literature 1, whether or not to allocate an individual passenger to a seat is expressed by a 01 variable, and conditions such as
(1) passengers in a multiple-people reservation are seated adjacent to each other, and
(2) 2 or more passengers are not allocated to the same seat for the same section are considered as constraint conditions.

In Patent Literature 1, an index of seating layout is given by the user.

### CITATION LIST

### Patent Literature

Patent Literature 1: JP No. H 11-328278

### SUMMARY OF INVENTION

### Technical Problem

The mathematical optimization problem in Patent Literature 1 is a 01 integer programming problem in a combinational optimization problem, so it takes time to calculate. Generally, in the 01 integer programming problem, the calculation time increases exponentially in accordance with count of 01 variables.

On the other hand, in formulation of Patent Literature 1, the count of 01 variables is defined by a product of a count of passengers and a count of seats, so the count of 01 variables increases in proportion to the count of passengers. Therefore, in Patent Literature 1, as the count of passengers increases, the calculation time increases.

Furthermore, in order to consider, as a constraint condition, seating passengers in a multiple-people reservation to be adjacent to each other, in Patent Literature 1, information on which reservation an individual passenger is associated with is required. Therefore, in Patent Literature 1, it is necessary to set the 01 variable for each individual passenger.

The present disclosure has as its objective to provide a device that reduces an increase in calculation time of an optimization problem which accompanies an increase in count of reservation people, by setting a decision variable not dependent on individual passengers.

### Solution to Problem

A seat reservation device according to the present disclosure includes:
a pattern extraction unit to extract, from a consecutive-seating pattern candidate group formed of a plurality of consecutive-seating patterns which are set per count of passenger-group people and arranged such that passengers of a same passenger group are consecutively seated,
a plurality of consecutive-seating patterns as a consecutive-seating pattern group, based on
reservation information which is information expressing a reservation for a target transportation facility and including a plurality of records each including a boarding section for the transportation facility and a same-time reservation people count being one unit of reservation people count, to make a reservation for a same operation schedule of the transportation facility, and
transportation facility information including a seat setting state of the transportation facility and a stop position at which the transportation facility of the same operation schedule stops;
a reservation totaling unit to total counts of suites per suite type having a same boarding section and a same same-time reservation people count, from the reservation information, and to generate a total result as total information;
a problem generation unit to generate an optimization problem on seating layout of reservation passengers, which involves a decision variable not dependent on a reservation people count, a constraint condition, and an objective function, based on the transportation facility information, an evaluation index designated as a guideline of the objective function, the consecutive-seating pattern group, and the total information;
a solution unit to solve the optimization problem and to decide the seating layout of the reservation passengers; and
an output unit to output the seating layout.

### Advantageous Effects of Invention

A seat reservation device of the present disclosure generates an optimization function for a seating layout which uses a decision variable not dependent on a count of reservation passengers. Therefore, even if a count of reservation people for a transportation facility increases, it is possible to decide a seating layout in a batch-process manner without increasing a scale of an optimization problem.

### BRIEF DESCRIPTION OF DRAWINGS

FIG. 1, being a diagram of Embodiment 1, is a system configuration diagram of a seat reservation system 1000.

FIG. 2, being a diagram of Embodiment 1, is a feature block diagram of a seat reservation device 100.

FIG. 3, being a diagram of Embodiment 1, illustrates reservation information 210.

FIG. 4, being a diagram of Embodiment 1, illustrates vehicle information 220.

FIG. 5, being a diagram of Embodiment 1, illustrates evaluation index information 230.

FIG. 6, being a diagram of Embodiment 1, illustrates a storage unit 102 in detail.

FIG. 7, being a diagram of Embodiment 1, is a flowchart illustrating operations of an input accepting unit 101.

FIG. 8, being a diagram of Embodiment 1, is a flowchart illustrating operations of seating layout decision processing.

FIG. 9, being a diagram of Embodiment 1, illustrates a consecutive-seating pattern group 240B extracted by a pattern extraction unit 103.

FIG. 10, being a diagram of Embodiment 1, is a concept view illustrating how the consecutive-seating pattern group 240B is extracted from a consecutive-seating pattern candidate group 240A.

FIG. 11, being a diagram of Embodiment 1, indicates A^{section}_{o,d,t}.

FIG. 12, being a diagram of Embodiment 2, illustrates reservation information 210.

FIG. 13, being a diagram of Embodiment 4, illustrates a hardware configuration of a seat reservation device 100.

FIG. 14, being a diagram of Embodiment 4, illustrates another hardware configuration of the seat reservation device 100.

### DESCRIPTION OF EMBODIMENTS

In descriptions and drawings of embodiments, the same elements and equivalent elements are denoted by the same reference sign. Description of the elements denoted by the same reference sign will be appropriately omitted or simplified. In the following embodiments, a term “unit” may be replaced by “circuit”, “stage”, “procedure”, “process”, or “circuitry” appropriately.

### Embodiment 1

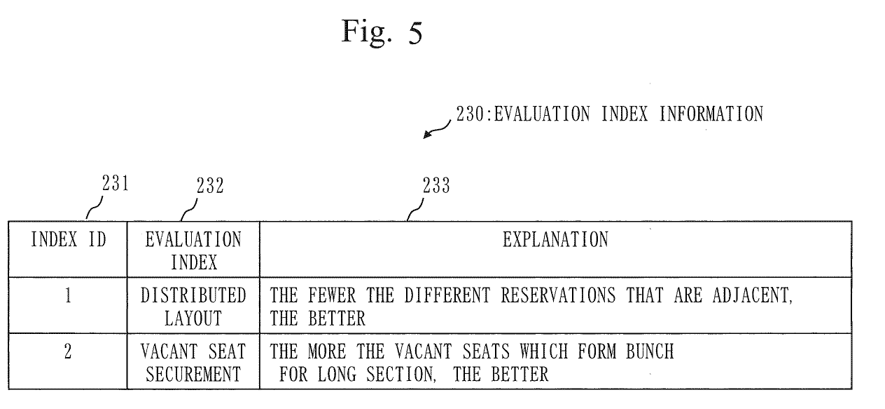

In Embodiment 1, an evaluation index 232 is the “distributed layout” to be described with referring to FIG. 5. In Embodiment 1, taking a train as an example of transportation facility, a case of deciding a seating layout of the train will be described.

### ***Description of Configurations***

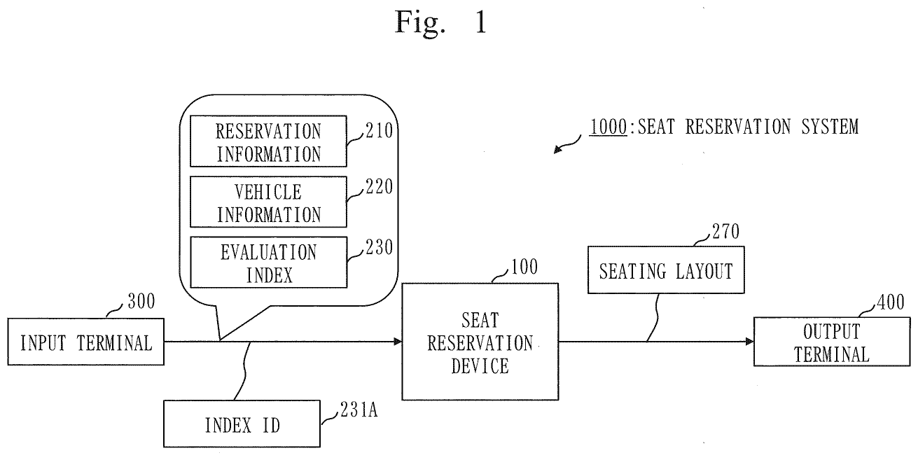

FIG. 1 is a system configuration diagram of a seat reservation system 1000 provided with a seat reservation device 100. The seat reservation system 1000 is provided with the seat reservation device 100, an input terminal 300, and an output terminal 400.

### <Seat Reservation Device 100>

The seat reservation device 100 decides a seating layout 270 for a train reservation. Information such as reservation information 210, vehicle information 220, and evaluation index information 230 are inputted to the seat reservation device 100 from the input terminal 300. The seat reservation device 100 outputs the seating layout 270 to the output terminal 400.

### <Input Terminal 300>

The input terminal 300 is a terminal device with which railway operation staff operates the seat reservation device 100. The input terminal 300 is a computer such as a tablet terminal and a smartphone. The input terminal 300 is not limited to a portable computer such as a tablet terminal and a smartphone. The seat reservation device 100 may serve as the input terminal 300. A plurality of input terminals 300 may be employed.

### <Output Terminal 400>

The output terminal 400 is a terminal device for outputting processing contents of the seat reservation device 100 to the railway operation staff.

For example, the output terminal 400 is a display or the like.

The input terminal 300 may also serve as the output terminal 400.

A plurality of output terminals 400 may be employed.

The seat reservation device 100 is applied as a constituent element of a seat reservation server 200.

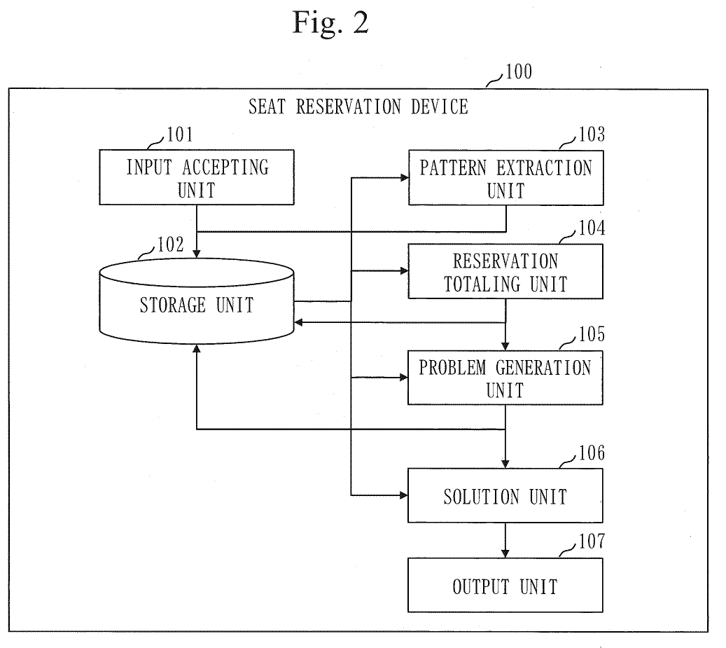

FIG. 2 is a feature block diagram of the seat reservation device 100. The seat reservation device 100 is provided with an input accepting unit 101, a storage unit 102, a pattern extraction unit 103, a reservation totaling unit 104, a problem generation unit 105, a solution unit 106, and an output unit 107. The input accepting unit 101 accepts information such as the reservation information 210, the vehicle information 220, and the evaluation index information 230 from the input terminal 300.

### <Reservation Information 210>

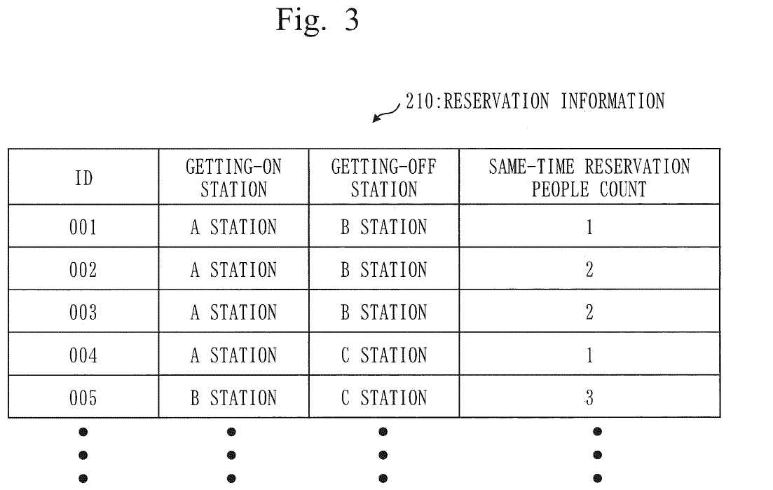

FIG. 3 illustrates the reservation information 210. As illustrated in FIG. 3, the reservation information 210 includes a plurality of records each having a getting-on station, a getting-off station, and a same-time reservation people count, which form a suite in an individual reservation as information of an existing reservation. Also, a record of a 2-people reservation for getting on at A station and getting off at B station is treated as
{A, B, 2}.
   Additional information such as ID which identifies a record may be added to the reservation information 210. FIG. 3 illustrates a case in which ID is added.

### <Vehicle Information 220>

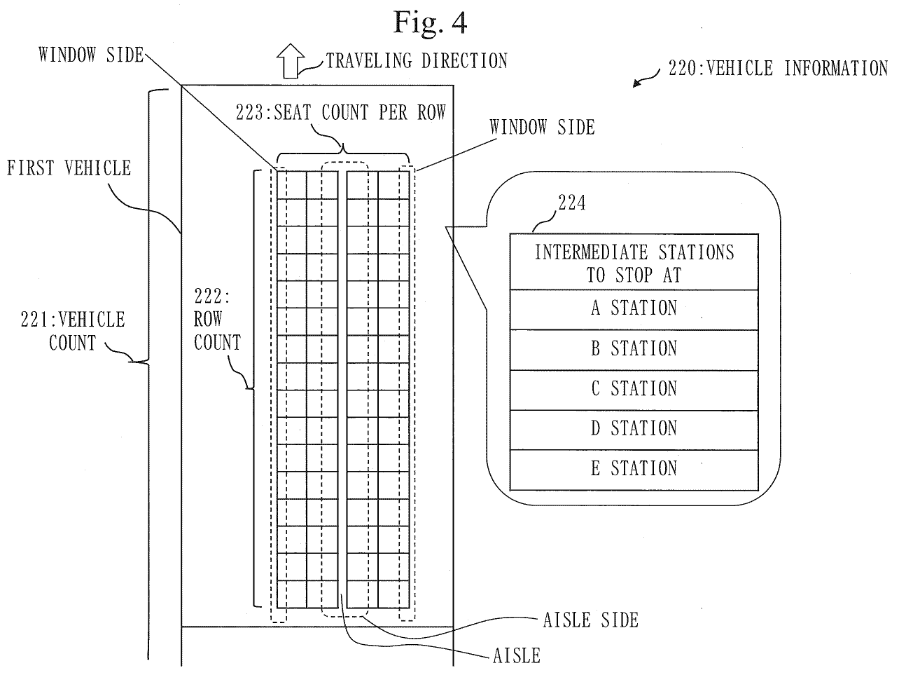

FIG. 4 illustrates the vehicle information 220. The vehicle information 220 includes configuration information concerning seats, such as a train vehicle count 221, a row count 222 of seats per vehicle, and a seat count 223 per row, as train information. The vehicle information 220 also includes information of intermediate stations 224 where the train stops. In the case of FIG. 4, regarding the first vehicle, the row count 222 per vehicle is 16, and the seat count 223 per row is 4. Stations where the train stops are A station, B station, C station, D station, and E station.

### <Evaluation Index Information 230>

FIG. 5 illustrates the evaluation index information 230. The evaluation index information 230 includes an index ID 231 and an evaluation index 232, as evaluation indices of an objective function employed when deciding the seating layout. Items of the index ID 231 and evaluation index 232 are defined in the storage unit 102 in advance. Index ID 231 corresponding to the evaluation index 232 to be used is supplied to the input accepting unit 101. The evaluation index information 230 may include additional information such as an explanation 233 on the evaluation index 232. In FIG. 5, an explanation 233 is added.

Information required for operations of the seat reservation device 100 is stored in the storage unit 102. Note that the storage unit 102 is not necessarily placed in the seat reservation device 100. The storage unit 102 may exist anywhere as far as the seat reservation device 100 can exchange information with the storage unit 102. For example, the storage unit 102 may be placed in a cloud and may communicate with the seat reservation device 100.

### <Storage Unit 102>

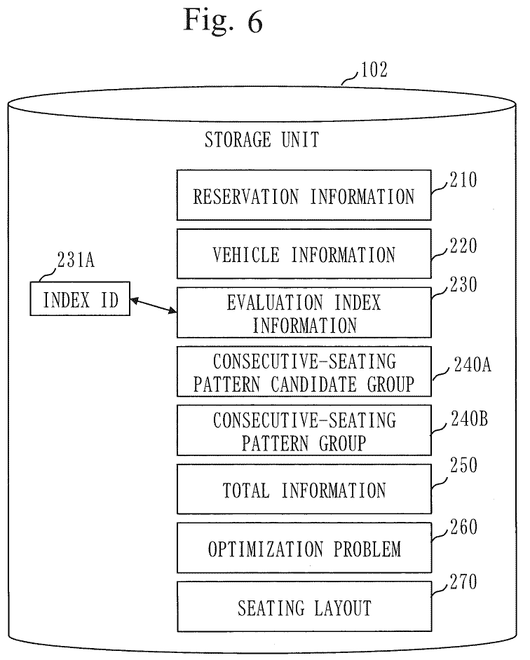

FIG. 6 illustrates the storage unit 102 in detail. The storage unit 102 stores the reservation information 210, the vehicle information 220, the evaluation index information 230, a consecutive-seating pattern candidate group 240A, a consecutive-seating pattern group 240B, total information 250, an optimization problem 260, and the seating layout 270.
(1) The reservation information 210 and the vehicle information 220 are information accepted by the input accepting unit 101.
(2) The evaluation index information 230 is defined in advance and stored in the storage unit 102. In the evaluation index information 230, index ID 231A accepted by the input accepting unit 101 and the evaluation index 232 of corresponding index ID are associated with each other.
(3) The consecutive-seating pattern candidate group 240A is formed of a plurality of consecutive-seating patterns. The consecutive-seating pattern candidate group 240A is stored in the storage unit 102 in advance. The consecutive-seating pattern group 240B is a group formed of a plurality of consecutive-seating patterns extracted by the pattern extraction unit 103 from the consecutive-seating pattern candidate group 240A. The consecutive-seating pattern group 240B is information stored in the storage unit 102 by the pattern extraction unit 103.
(4) The total information 250 is information generated by the reservation totaling unit 104 and stored in the storage unit 102 by the reservation totaling unit 104.
(5) The optimization problem 260 is information generated by the problem generation unit 105 and stored in the storage unit 102 by the reservation totaling unit 104.

### <Pattern Extraction Unit 103>

The pattern extraction unit 103 extracts, based on the reservation information 210 and the vehicle information 220 which are stored in the storage unit 102, the consecutive-seating pattern group 240B corresponding to the reservation information 210 and vehicle information 220 from candidates in the consecutive-seating pattern candidate group 240A defined by the storage unit 102 in advance. The pattern extraction unit 103 stores the extracted consecutive-seating pattern group 240B to the storage unit 102. A specific way of the acquisition will be described later.

### <Reservation Totaling Unit 104>

The reservation totaling unit 104 totals counts of suites each formed of a getting-on station, a getting-off station, and a same-time reservation people count, based on the reservation information 210, and stores a total result to the storage unit 102 as the total information 250. A specific way of totaling will be described later.

### <Problem Generation Unit 105>

The problem generation unit 105 generates the optimization problem 260 based on the vehicle information 220, the evaluation index information 230, the consecutive-seating pattern group 240B, and the total information 250, and stores the optimization problem 260 to the storage unit 102. A specific way of the generation will be described later.

### <Solution Unit 106>

The solution unit 106 solves the optimization problem 260 generated by the problem generation unit 105 to decide and generate the seating layout 270. A specific way of deciding the seating layout 270 will be described later.

### <Output Unit 107>

The output unit 107 outputs the seating layout 270 to the output terminal 400.

### ***Description of Operations***

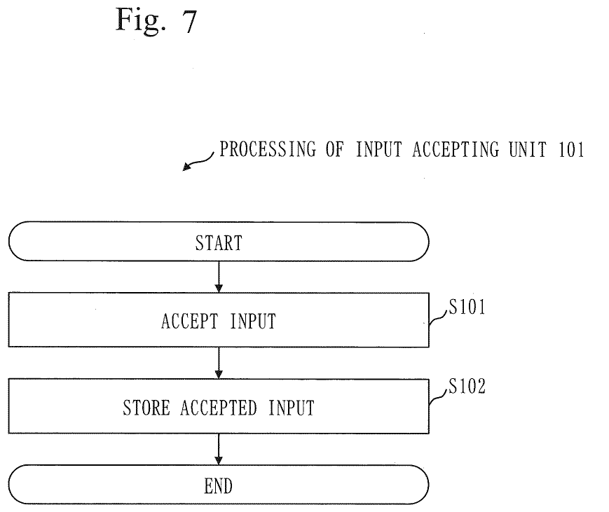

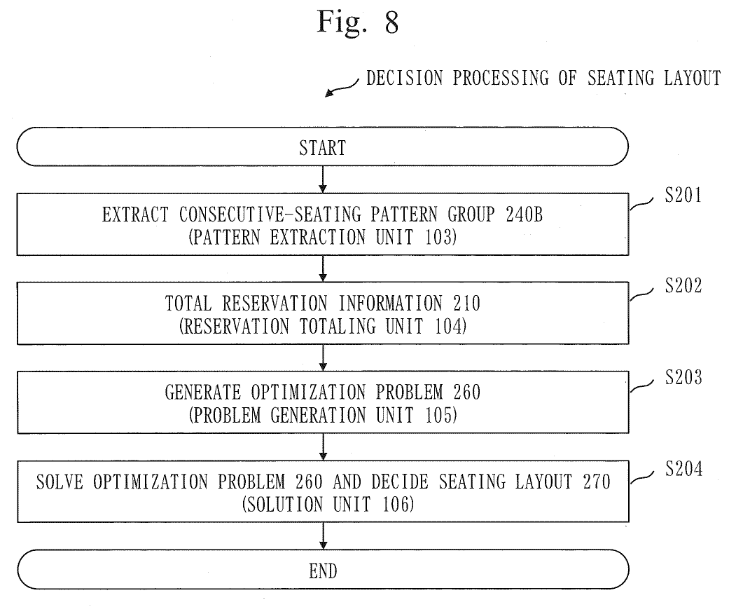

FIG. 7 illustrates operations of the input accepting unit 101. FIG. 8 illustrates operations of seating layout decision processing. The operations of the seat reservation device 100 will be described with referring to FIGS. 7 and 8.

Input accepting operations of the input accepting unit 101 will be described with referring to FIG. 7.

### <Step S101>

In step S101, the input accepting unit 101 accepts the reservation information 210, the vehicle information 220, and the index ID 231A as input information.

### <Step S102>

In step S102, the input accepting unit 101 stores the reservation information 210, the vehicle information 220, and the index ID 231A to the storage unit 102. The input accepting unit 101 associates the index ID 231A with a record having the same index ID 231 in the evaluation index information 230. In later step S203, the problem generation unit 105 generates the optimization problem 260 using the evaluation index of this record.

The operations of decision processing of the seating layout will be described with referring to FIG. 8.

### <Step S201>

In step S201, based on the reservation information 210 and vehicle information 220 of the storage unit 102, the pattern extraction unit 103 extracts the consecutive-seating pattern group 240B formed of a plurality of consecutive-seating patterns corresponding to the reservation information 210 and the vehicle information 220, from the consecutive-seating pattern candidate group 240A in the storage unit 102.

The reservation information 210 is information indicating a reservation for a target transportation facility. As illustrated in FIG. 3, the reservation information 210 is information including a plurality of records each including a boarding section for the transportation facility, and a same-time reservation people count being one unit of reservation people count, to make a reservation for the same operation schedule of the transportation facility. In Embodiment 1, the transportation facility is a train. The row of each ID of FIG. 3 constitutes a reservation record. In FIG. 3, a getting-on station and a getting-off station form a boarding section. The same-time reservation people count of FIG. 3 constitutes one unit of reservations for the same operation schedule. Reservations for the same operation schedule mean reservations for an operation schedule of train T leaving A station at 12:00, Jan. 1, 2022 and arriving at Z station at 15:00, Jan. 1, 2022. The first operation schedule of train T leaving A station at 12:00, Jan. 1, 2022 and arriving at Z station at 15:00, Jan. 1, 2022 and the second operation schedule of train T leaving A station at 12:00, Jan. 2, 2022 and arriving at Z station at 15:00, Jan. 2, 2022 are two different operation schedules. One unit of reservations is reservations of a plurality of people belonging to the same group. It is possible to treat reservations of a plurality of people as a reservation of one or more people.

The vehicle information 220 is information including a train seat setting state and a stop position at which the train of the same operation schedule stops. In the vehicle information 220 of FIG. 4, the vehicle count 221, the row count 222, and the seat count 223 per row are the train seat setting state.

The intermediate station 224 where train stops is the stop position at which the train stops.

First, the pattern extraction unit 103 extracts a maximum value of the same-time reservation people count from the reservation information 210. Next, the pattern extraction unit 103 extracts the seat count 223 per row from the vehicle information 220. After that, based on the maximum value of the same-time reservation people count and the seat count 223 per row, the pattern extraction unit 103 extracts the consecutive-seating pattern group 240B formed of a plurality of consecutive-seating patterns corresponding to the maximum value and the seat count 223 from the consecutive-seating pattern candidate group 240A.

### <Consecutive-Seating Pattern Group 240B>

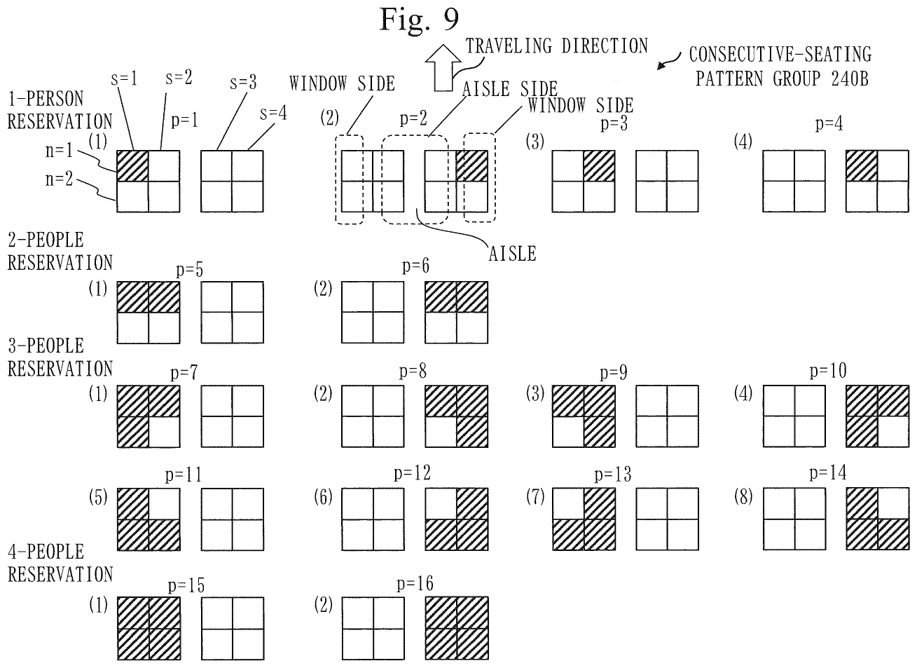

FIG. 9 illustrates the consecutive-seating pattern group 240B extracted from the consecutive-seating pattern candidate group 240A by the pattern extraction unit 103. The consecutive-seating pattern group 240B is an extraction result. The consecutive-seating pattern candidate group 240A, being an extraction source, is formed of a plurality of consecutive-seating patterns which are set per count of passenger-group people and arranged such that passengers of the same passenger group are consecutively seated.

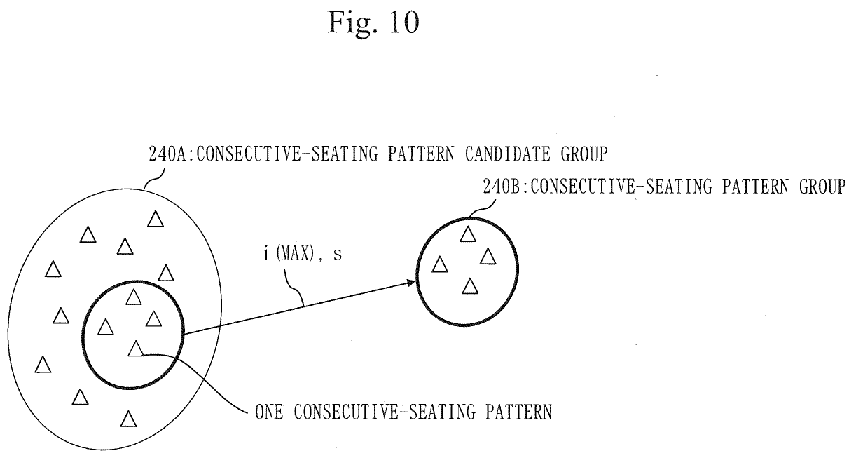

FIG. 10 is a concept view illustrating how the consecutive-seating pattern group 240B is extracted from the consecutive-seating pattern candidate group 240A. FIG. 9 illustrates the consecutive-seating pattern group 240B of a case where the maximum value of the same-time reservation people count in the reservation information 210 (FIG. 3) is 4 and the seat count 223 per row in the vehicle information 220 is 4. The consecutive-seating pattern group 240B is a set of consecutive patterns that define, for each row having a seat count of 4, allocating the reservation passengers to which seats among the seats existing in that row and in a subsequent row. FIG. 9 indicates that when the maximum value of the same-time reservation people count is 4 and the seat count 223 is 4, following consecutive-seating patterns are extracted for 1-person to 4-people reservations.

For a 1-person reservation, 4 consecutive-seating patterns of (1) to (4) are extracted.

For a 2-people reservation, 2 consecutive-seating patterns of (1) and (2) are extracted.

For a 3-people reservation, 8 consecutive-seating patterns of (1) to (8) are extracted.

For a 4-people reservation, 2 consecutive-seating patterns of (1) and (2) are extracted.

Hatched squares in FIG. 9 express seats to be allocated in each consecutive-seating pattern. Non-hatched squares express seats not allocated in that consecutive-seating pattern.

The consecutive-seating pattern is expressed by a constant like
A^{pattern}_{p,n,s}.

The suffixes have meanings as follows:
p expresses a consecutive-seating pattern,
n expresses a place number of a certain row when counted from a pertinent row, and
s expresses a seat in a row.

In FIG. 9, 16 consecutive-seating patterns are numbered from p=1 to p=16.

The meanings of n and s are mentioned in (1) in 1-person reservation.

Also,
A^{pattern}_{p,n,s} takes either value of 1 or 0,
A^{pattern}_{p,n,s}=1 indicates that that seat s is allocated to a person, and
A^{pattern}_{p,n,s}=0 indicates that that seat s is allocated to no person.

That is, A^{pattern}_{p,n,s} signifies whether to perform allocation for an n-th row, s-th seat in a consecutive-seating pattern p.

For example, in the drawing, A^{pattern}_{p,n,s} is as follows.
A^{pattern}_{1,1,1}=1, A^{pattern}_{1,1,2}=0

The consecutive-seating pattern group 240B in FIG. 9 is an example. That is, the consecutive-seating pattern candidate group 240A as an extraction source of the consecutive-seating pattern group 240B can be defined arbitrarily. A seat arrangement like 4 seats in 1 row of FIG. 9 is an example. The pattern extraction unit 103 stores the consecutive-seating pattern group 240B extracted from the consecutive-seating pattern candidate group 240A to the storage unit 102.

### <Step S202>

In step S202, the reservation totaling unit 104 totals counts of suites per suite type having the same boarding section and the same same-time reservation people count, from the reservation information 210, and generates a total result as the total information 250. The reservation totaling unit 104 generates the total information 250 by totaling counts of suites having the same {getting-on station, getting-off station, same-time reservation people count}, based on the reservation information 210 of FIG. 3.

Specifically, the reservation totaling unit 104 totals counts of suites per different suite type, like:
15 suites of 2-people reservations getting on at A station and getting off at B station,
30 suites of 2-people reservations getting on at A station and getting off at C station, and
20 suites of 3-people reservations getting on at A station and getting off at C station.

Totaling of 15 suites, 30 suites, 20 suites, and so on mentioned above is sometimes expressed as follows.

$$\{ A , B , 2 \} = 15$$

$$\{ A , C , 2 \} = 30$$

$$\{ A , C , 3 \} = 20$$

A whole part of {A, B, 2}=15, {A, C, 2}=30, and {A, C, 3}=20 is the total information 250. The reservation totaling unit 104 stores the generated total information 250 to the storage unit 102.

### <Step S203>

In step S203, the problem generation unit 105 generates an optimization problem on seating layout of reservation passengers, which involves a decision variable not dependent on a reservation people count, a constraint condition, and an objective function, based on the vehicle information 220, the evaluation index 232, the consecutive-seating pattern group 240B, and the total information 250.

The vehicle information 220 is transportation facility information. The evaluation index 232 is an evaluation index designated by the index ID 231A as a guideline of the objective function. A following relationship exists between the evaluation index and the objective function. That is, the evaluation index is an index that evaluates good or bad of the seating layout. The objective function is a specific function expressing the evaluation index.

The problem generation unit 105 generates the decision variable that expresses whether or not there is seat allocation of a reservation passenger, by a unit of each consecutive-seating pattern of the consecutive-seating pattern group 240B. This will be specifically described below.

The problem generation unit 105 generates the optimization problem 260 involving (1) the decision variable, (2) the constraint condition, and (3) the objective function, based on (1) the vehicle information 220, (2) the evaluation index 232 designated by the index ID 231A, (3) the consecutive-seating pattern group 240B, and (4) the total information 250, which are stored in the storage unit 102.

### <Constraint Condition>

The problem generation unit 105 generates, as a constraint condition, an overlapping constraint (1, 1) which constraints each seat from being allocated to two or more reservations for the same boarding section. The problem generation unit 105 also generates, as a constraint condition, a reservation count constraint (1, 2) indicating that a total allocatable count of reservations of suites each consisting of a boarding section and a same-time reservation people count is the same as the total value of the total information 250.

The overlapping constraint (1, 1) and the reservation count constraint (1, 2) exist as the constraint conditions that must be generated essentially. The overlapping constraint (1, 1) is a constraint condition indicating that each seat must not be allocated to 2 or more reservations for the same boarding section.

The overlapping constraint (1, 1) is expressed by following Expression 1.

Expression 1 uses a 01 variable X_{o,d,p,v,c} expressing whether or not to allocate a reservation of the consecutive-seating pattern p for boarding sections starting from a boarding section o and ending at a boarding section d, to a row c of a vehicle v, as a decision variable.

$$\begin{matrix}[ Formula 1 ] & \\ {\sum }_{p ∈ Pg} {\sum }_{o ∈ Tg} {\sum }_{d ∈ \{ o , ... , T \}} {\sum }_{n = 1}^{min ( c , N )} {A}_{o , d , t}^{section} {A}_{p , n , s}^{pattern} {x}_{o , d , p , v , c - n + 1} \leq 1 , & ( Expression 1 )\end{matrix}$$

$$∀ v ∈ Vg , c ∈ Cg , ∀ s ∈ Sg , ∀ t ∈ Tg .$$

In Expression 1, note that
P_{g} expresses the consecutive-seating pattern group 240B,
V_{g}={1, . . . , V} expresses a set of vehicles,
C_{g}={1, . . . , C} expresses a set of rows,
S_{g}={1, . . . , S} expresses a set of seats in a row, and
T_{g}=1, . . . , T} expresses a set of boarding sections.

In each set,
V denotes a vehicle count,
C denotes a row count,
S denotes a seat count per row, and
T denotes a count of boarding sections {(count of intermediate stations where the train stops)−1}.

Note that V, C, S, and T are determined from the vehicle information 220.

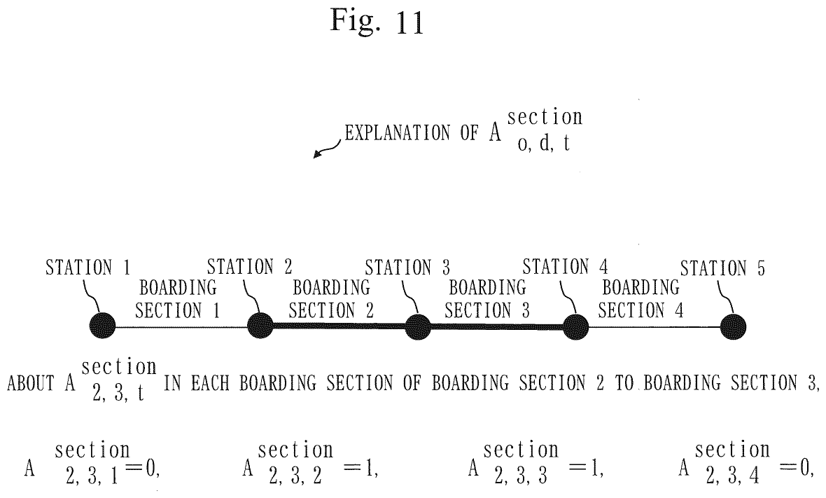

FIG. 11 indicates A^{section}_{o,d,t}. A^{section}_{o,d,t} is a constant indicating whether a boarding section t is involved in boarding sections consisting of a boarding section o to a boarding section d. If the boarding section t is involved, A^{section}_{o,d,t} takes a value of 1; if not involved, takes a value of 0. A^{section}_{o,d,t} is also determined from the vehicle information 220.

Note that N in min(c, N) of Expression 1 expresses a maximum value of a count of rows occupying all consecutive-seating patterns of the consecutive-seating pattern group 240B.

In FIG. 9, N=2.

A left side of Expression 1 expresses, regarding each seat and each boarding section, a total count of reservations allocated to that seat and that boarding section. The left side must always be 1 or less.

### <Reservation Count Constraint>

The reservation count constraint (1, 2) is a constraint condition indicating that a total allocatable count of reservations corresponding to
a suite of {a getting-on station, a getting-of station, a same-time reservation people count}
   is the same as the total value obtained from the total information 250.

For example, assume that there are 15 suites of reservations for getting on at A station and getting off at B station with a same-time reservation people count of 2.

Namely, assume that

$$( A , B , 2 ) = 15.$$

In this case, a constraint is stipulated that there must be a total of 15 suites to which 2-people reservation patterns (1) and (2) of FIG. 9 are allocated. A condition of reservation count constraint (1, 2) is expressed by following Expression 2.

$$\begin{matrix}[ Formula 2 ] & \\ {\sum }_{v ∈ Vg} {\sum }_{c ∈ Cg} {\sum }_{p ∈ {P}_{( i )}} {x}_{o , d , p , v , c} = {B}_{i , o , d} , & ( Expression 2 )\end{matrix}$$

$$∀ i ∈ \{ 1 , ... , I \} , ∀ o ∈ Tg , ∀ d ∈ \{ o , ... , T \} .$$

In Expression 2, note that
I is a maximum value i (MAX) of a same-time reservation people count i,
P₍ᵢ₎ is a set of consecutive-seating patterns for i-person reservation,
P₍ᵢ₎ is stipulated by the consecutive-seating pattern group 240B, and
B_{i,o,d} is a total count of i-person reservations for boarding sections starting from the boarding section o and ending at the boarding section d. Note that B_{i,o,d} is stipulated by the total information 250.

In Embodiment 1, the designated evaluation index is a distributed layout defining that the fewer the seats being from different reservations are adjacent, the better. The problem generation unit 105 generates the objective function that minimizes the seats which are from the different reservations and adjacent to each other, in accordance with the distributed layout of the evaluation index.

Regarding the evaluation index information 230 of FIG. 5, a specific example of the objective function will be described below in a case where upon input of the index ID 231A, “distributed layout” of the index ID=1 is selected. In this distributed layout, the objective function is to minimize a count of passengers from different reservations and seated adjacent to each other, and to minimize the adjacent boarding sections for those passengers, as in the explanation 233 of the evaluation index information 230.

Specifically, assume that allocation has been done for individual seats and individual boarding sections. Also assume an auxiliary variable that is 1 when allocation has been made to a seat on the right facing the traveling direction in the relevant boarding section, and is 0 otherwise. An evaluation index that minimizes a sum total of the auxiliary variables is set. This auxiliary variable is 1 regardless of the seating layout when passengers seated adjacent to each other are from the same reservation, and thus can be regarded as a fixed value. Therefore, the larger the count of passengers who are from different reservations and seated adjacent to each other, and the larger the count of adjacent boarding sections for those passengers, the larger the total sum of the auxiliary variables. The optimization problem generated by the problem generation unit 105 is stored in the storage unit 102 as the optimization problem 260.

### <Step S204>

In step S204, the solution unit 106 solves the optimization problem 260 stored in the storage unit 102 and decides the seating layout 270 of the reservation passengers to respond to the reservation information 210. As a specific way of solving the optimization problem 260, an arbitrary existing technique such as a versatile integer programming solver can be employed.

### ***Effect of Embodiment 1***

The seat reservation device 100 determines whether allocation can be made for seats which form a bunch for a certain count of people. Thus, unlike in Patent Literature 1, when guaranteeing that passengers in a multiple-people reservation are seated adjacent to each other, the seat reservation device 100 does not require information on which reservation each individual passenger is associated with. That is, 01 variable X_{o,d,p,v,c} in the embodiment is not dependent on the count of passengers. Therefore, even when the passenger reservation count increases, it is possible to realize batch-like decision calculation for a seating layout in which reservations each being different from an existing reservation are distributed, without increasing a scale of the optimization problem.

The seat reservation device 100 sets the 01 variable not for each individual passenger but for each reservation attribute (same-time reservation people count), thereby keeping the count of 01 variables constant regardless of the count of passengers. As a result, an increase in calculation time of the optimization problem can be prevented.

### Embodiment 2

Embodiment 2 will be described below. In Embodiment 2, a seating layout 270 is decided with considering window-side designation, aisle-side designation, or no designation in 1-person reservation, in addition to in multiple-people reservation. A passenger group in reservation information 210 may be formed of one or more passengers as in FIG. 3, just like in Embodiment 1. Each record in FIG. 3 corresponds to a passenger group.

A consecutive-seating pattern candidate group 240A involves a plurality of consecutive-seating patterns corresponding to a passenger group of 1-person. This corresponds to 1-person reservation of FIG. 9.

Differences from Embodiment 1 are
(1) the reservation information 210,
(2) the reservation totaling unit 104,
(3) step S202, and
(4) step S203.

Only the differences from Embodiment 1 will be described.

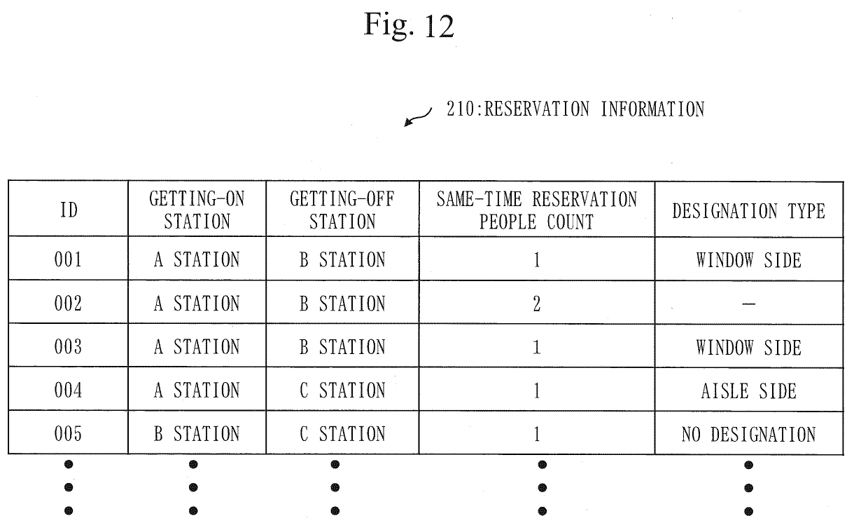

Regarding “(1) the reservation information 210”, the reservation information 210 includes a 1-person reservation record indicating 1-person reservation in which the same-time reservation people count is 1 and which includes a designation type of window-side designation, aisle-side designation, or no designation. In FIG. 12 to be described later, ID=001, ID=003, ID=004, and ID=005 are each a 1-person reservation record.

Regarding “(2) the reservation totaling unit 104” and “(3) step S202”, for 1-person reservation, the reservation totaling unit 104 totals counts of suites per suite type having the same designation type and the same boarding section, from the reservation information 210, and generates total information 250 including a total result of the 1-person reservation.

Regarding “(4) step S203”, a problem generation unit 105 generates a constraint condition of following Expression 3 which indicates that a total allocatable count for 1-person reservations is the same as the sum total of a total value of the window-side designation in the total information, a total value of the aisle-side reservation in the total information, and a total value of the no designation in the total information. The problem generation unit 105 also generates a constraint condition of following Expression 4 which indicates that an allocable count of consecutive-seating patterns corresponding to the window-side designation is not smaller than the total value of the window-side designation, and that an allocable count of consecutive-seating patterns corresponding to the aisle-side designation is not smaller than the total value of the aisle-side designation.

The problem generation unit 105 generates Expression 3 and Expression 4, based on vehicle information 220, evaluation index information 230, a consecutive-seating pattern group 240B, and total information 250. A specific example will be described below.

FIG. 12 illustrates reservation information 210 of Embodiment 2. The reservation information 210 has items including a getting-on station, a getting-off station, a same-time reservation people count, and designation type in 1-person reservation, as reservation record items. The designation type is window-side reservation, aisle-side reservation, or no designation.

For example, a 1-person reservation for getting on at A station and getting off at B station with window-side designation is treated as a suite {A, B, 1, window side}. Each designation of window-side designation, aisle-side designation, and no side designation can be made only for 1-person designation.

### <Step S202>

In step S202, the reservation totaling unit 104 totals a count of suites of (getting-on station, getting-off station, same-time reservation people count) based on the reservation information 210, and generates the total information 250. Specifically, about multiple-people reservations, the reservation totaling unit 104 totals counts of reservations per different suite type, such as

$$\{ A , B , 2 \} = 15 ,$$

$$\{ A , C , 2 \} = 30 , and$$

$$\{ A , C , 3 \} = 20 ,$$

in the same manner as in step S202 of Embodiment 1.

As for 1-person reservation, the reservation totaling unit 104 totals reservations designating a window-side seat, reservations designating an aisle-side seat, and reservations not designating a window-side seat nor an aisle-side seat, separately in the same manner as for the multiple-people reservations.

Specifically, in FIG. 12, the problem generation unit 105 totals counts of different 1-person reservations per suite type, such as
{A, B, 1, window side}=2,
{A, C, 1, aisle side}=1, and
{B, C, 1, no designation}=1.

### <Step S203>

A constraint condition in 1-person reservation is added to the reservation count constraint of step S203 in order to take into consideration the window-side designation and the aisle-side designation in 1-person reservation.

Specifically, the problem generation unit 105 generates a constraint condition on a reservation count in 1-person reservation, on the basis that a total allocable count of 1-person reservations at a getting-on station and a getting-off station is the same as a sum total of a total value of reservations designating a window-side seat, reservations designating an aisle-side seat, and reservations not designating a window-side seat nor an aisle-side seat. This constraint condition is expressed by Expression 3 below.

$$\begin{matrix}[ Formula 3 ] & \\ {\sum }_{v ∈ Vg} {\sum }_{c ∈ Cg} {\sum }_{p ∈ {P}_{( 1 )}} {x}_{o , d , p , v , c} = {\sum }_{i ∈ \{ 1 , 1 w , 1 a \}} {B}_{i , o , d} , & ( Expression 3 )\end{matrix}$$

$$∀ o ∈ Tg , ∀ d ∈ \{ o , ... , T \} .$$

In Expression 3, regarding a reservation people count i, note that
1w expresses 1-person reservation with window-side designation,
1a expresses 1-person reservation with aisle-side designation, and
1 expresses 1-person reservation with no designation.

Also, regarding the consecutive-seating pattern, note that
P₍₁₎=P_{(1w)}∪P₍₁ₐ₎ where P_{(1w)} and P₍₁ₐ₎ have nothing in common.

In FIG. 9, (2) of 1-person reservation explains window side and aisle side.

Note that
P_{(1w)} corresponds to (1) and (2) of 1-person reservation of FIG. 9,
P₍₁ₐ₎ corresponds to (3) and (4) of 1-person reservation, and
P₍₁₎ corresponds to (1), (2), (3), and (4) of 1-person reservation.

About 1-person reservation with type designation, constraint conditions (1) and (2) below are further added.
(1) An allocable count for consecutive-seating patterns corresponding to the window side must not be smaller than a total value of reservations designating a window-side seat.
(2) An allocable count for consecutive-seating patterns corresponding to the aisle side must not be smaller than a total value of reservations designating an aisle-side seat.

The constraint conditions (1) and (2) are expressed by Expression 4.

The problem generation unit 105 generates the constraint conditions of Expression 4.

$$\begin{matrix}[ Formula 4 ] & \\ {\sum }_{v ∈ Vg} {\sum }_{c ∈ Cg} {\sum }_{p ∈ {P}_{( i )}} {x}_{o , d , p , v , c} \geq {B}_{i , o , d} , & ( Expression 4 )\end{matrix}$$

$$∀ i ∈ \{ 1 w , 1 a \} , ∀ o ∈ Tg , ∀ d ∈ \{ o , ... , T \} .$$

Assume that
a total count of 1-person reservations designating the window side is 5,
a total count of 1-person reservations designating the aisle side is 7, and
a total count of 1-person reservations designating neither the window side or aisle side is 8.

A total count of 1-person reservations is 20.

The 20 reservations are allocated each as either a window-side consecutive-seating pattern or as an aisle-side consecutive-seating pattern.

From the constraint conditions of Expression 4, the seats will be allocated as follows.

An allocable count for window-side consecutive-seating patterns is not smaller than 5.

An allocable count for aisle-side consecutive-seating patterns is not smaller than 7.

Thus, a seating layout not contradictory to the total information 250 can be decided.

### ***Effect of Embodiment 2***

According to the configuration of Embodiment 2, a decision variable not dependent on a count of passengers can be set also when window-side designation in 1-person reservation and aisle-side designation in 1-person reservation are taken into consideration. Then, even when the passenger count increases, it is possible to realize batch-like decision calculation for a seating layout in which reservations each being different from an existing reservation are distributed, without increasing a scale of the optimization problem.

### Embodiment 3

Embodiment 3 will be described below. In Embodiment 3, the evaluation index is “securing vacant seat” in the evaluation index information 230 of FIG. 5. Index ID 2 is inputted to a seat reservation device 100. The seat reservation device 100 decides a seating layout of a train by “vacant seat securement”.

The vacant seat securement is an evaluation index which defines that the more the vacant seats which form a bunch, the better. A problem generation unit 105 generates an objective function that secures vacant seats in a rear part of the train of the same operation schedule with respect to a traveling direction, for sections from a start point at which the train starts moving to an end point at which the train stops moving, in accordance with the vacant seat securement of the evaluation index, so as to reduce vacant seats in a forward part and to increase acceptable reservations.

A difference of Embodiment 3 from Embodiment 1 is the objective function generated in step S203.

Only the difference from Embodiment 1 will be described.

In evaluation index information 230, assume that “securing vacant seat” is designated as an evaluation index 232 by an index ID 231A. A specific example of the objective function of this case will be described below. It is supposed that the problem generation unit 105 generates an objective function which, when “securing vacant seat” is designated as the evaluation index, maximizes a count of rows where the seats are vacant for all the boarding sections from the start point until the end point of the train and with which the further rear the row in the train with respect to the traveling direction, the lager the weight.

Specifically, the problem generation unit 105 assumes, for individual rows, an auxiliary variable that is 0 if there is at least one reservation-allocated seat in any boarding section, and is 1 otherwise. Then, the problem generation unit 105 generates an objective function that maximizes a total sum of products of row numbers and auxiliary variables.

A reason of generating such an objective function is as follows. When vacant seats which form a bunch for a long section are secured more in the rear part, extra vacant seats in the forward part become less. Then, more reservations can be accepted.

### ***Effect of Embodiment 3***

Note that 01 variable X_{o,d,p,v,c} in Embodiment 3 is not dependent on the count of passengers. Therefore, in a case where the evaluation index is “securing vacant seat” as well, even when the passenger count increases, it is possible to realize batch-like decision calculation for a seating layout in which many vacant seats that form a bunch are secured for a long section against existing reservations, without increasing a scale of the optimization problem.

Regarding a layout to be aimed at, various evaluation indices may be possible depending on the case such as distributed layout of different passengers and equalization of densities in the vehicles. However, the seat reservation device 100 of Embodiments 1 to 3 does not depend on the contents of the evaluation indices.

Embodiments 1 to 3 have been described so far. Of these embodiments, two or more may be practiced in combination. Of a plurality of technical matters involved in one embodiment, one technical matter may be practiced partly. Alternatively, technical matters involved in different embodiments may be practiced in partial combination.

### Embodiment 4

### <Hardware Configuration of Seat Reservation Device 100>

In Embodiment 4, a hardware configuration of the seat reservation device 100 according to Embodiments 1 to 3 will be described.

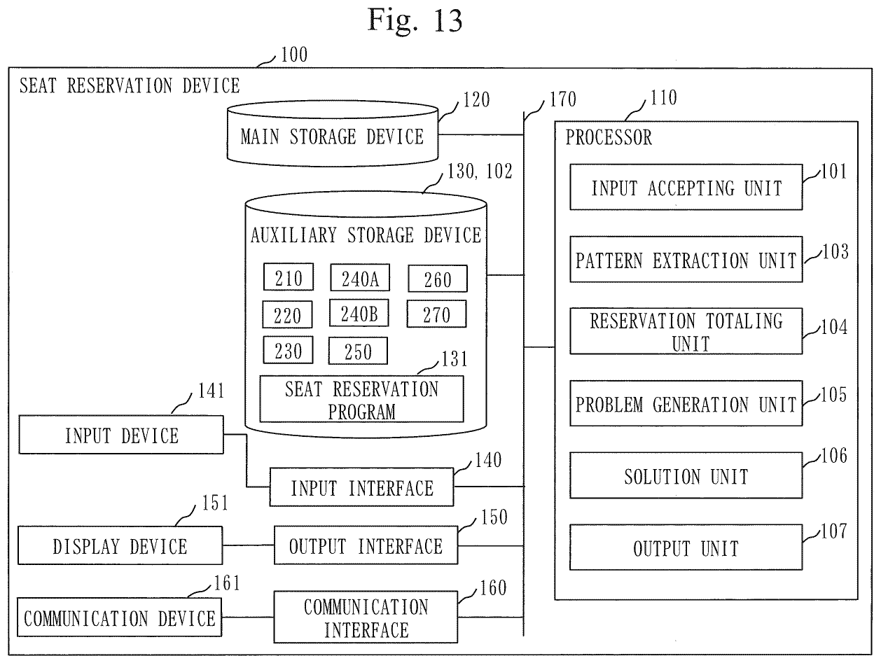

FIG. 13 illustrates the hardware configuration of the seat reservation device 100. The hardware configuration of the seat reservation device 100 will be described with referring to FIG. 13.

The seat reservation device 100 is a computer. The seat reservation device 100 is provided with a processor 110. The seat reservation device 100 is provided with a plurality of hardware devices in addition to the processor 110. The plurality of hardware devices are a main storage device 120, an auxiliary storage device 130, an input interface 140, an output interface 150, and a communication interface 160. The processor 110 is connected to the other hardware devices via a signal line 170 and controls the other hardware devices.

The seat reservation device 100 is provided with an input accepting unit 101, a pattern extraction unit 103, a reservation totaling unit 104, a problem generation unit 105, a solution unit 106, and an output unit 107, as feature elements. Features of the input accepting unit 101, pattern extraction unit 103, reservation totaling unit 104, problem generation unit 105, solution unit 106, and output unit 107 are implemented by a seat reservation program 131.

The processor 110 is a device that runs the seat reservation program 131. As the processor 110 runs the seat reservation program 131, the features of the input accepting unit 101, pattern extraction unit 103, reservation totaling unit 104, problem generation unit 105, solution unit 106, and output unit 107 are implemented. The processor 110 is an Integrated Circuit (IC) which performs computation processing. Specific examples of the processor 110 are a Central Processing Unit (CPU), a Digital Signal Processor (DSP), and a Graphics Processing Unit (GPU).

The main storage device 120 is a storage device. Specific examples of the main storage device 120 are a Static Random-Access Memory (SRAM) and a Dynamic Random-Access Memory (DRAM). The main storage device 120 holds a computation result of the processor 110.

The auxiliary storage device 130 is a storage device to keep data in a nonvolatile manner. A specific example of the auxiliary storage device 130 is a Hard Disk Drive (HDD). The auxiliary storage device 130 may be a portable recording medium. Examples of the portable recording medium include a Secure Digital (SD, registered trademark) memory card, a NAND flash, a flexible disk, an optical disk, a compact disk, a Blu-ray (registered trademark) disc, and a Digital Versatile Disk (DVD). The auxiliary storage device 130 stores the seat reservation program 131. The auxiliary storage device 130 keeps reservation information 210, vehicle information 220, evaluation index information 230, a consecutive-seating pattern candidate group 240A, a consecutive-seating pattern group 240B, total information 250, an optimization problem 260, and a seating layout 270. The auxiliary storage device 130 implements the storage unit 102. The feature of the auxiliary storage device 130 may be covered by a cloud server.

The input interface 140 is a port to which data is inputted from the devices. In FIG. 13, the input interface 140 is connected to an input device 141. The output interface 150 is connected to various apparatuses. The output interface 150 is a port via which data is outputted to the various apparatuses by the processor 110. In FIG. 13, the output interface 150 is connected to a display device 151. The communication interface 160 is a port via which the processor communicates with another device. In FIG. 13, the communication interface 160 is connected to a communication device 161.

The processor 110 loads the seat reservation program 131 from the auxiliary storage device 130 to the main storage device 120. The processor 110 reads the loaded seat reservation program 131 from the main storage device 120 and runs the seat reservation program 131. In addition to the seat reservation program 131, an Operating System (OS) is also stored in the main storage device 120. The processor 110 runs the seat reservation program 131 while running the OS. The seat reservation device 100 may be provided with a plurality of processors that substitute for the processor 110. The plurality of processors run the seat reservation program 131 by sharing. Each processor is a device that runs the seat reservation program 131, just as the processor 110 does. Data, information, signal values, and variable values utilized, processed, or outputted by the seat reservation program 131 are stored in the main storage device 120, the auxiliary storage device 130, or a register or cache memory in the processor 110.

The seat reservation program 131 is a program that causes the computer to execute processes, procedures, or stages which are the input accepting unit 101, the pattern extraction unit 103, the reservation totaling unit 104, the problem generation unit 105, the solution unit 106, and the output unit 107, each with the term “unit” being replaced by “process”, “procedure”, or “stage”.

A seat reservation method is a method as the seat reservation device 100 being a computer runs the seat reservation program 131. The seat reservation program 131 may be provided in a form of being stored in a computer readable recording medium, or may be provided as a program product.

The features of the seat reservation device 100 described with referring to FIG. 13 are implemented by the seat reservation program 131. Alternatively, the features of the seat reservation device 100 may be implemented by hardware.

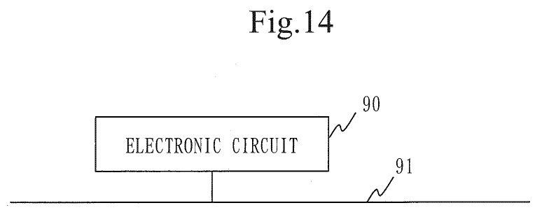

FIG. 14 illustrates a configuration in which the features of the seat reservation device 100 are implemented by hardware. An electronic circuit 90 of FIG. 14 is a dedicated electronic circuit that implements the features of the input accepting unit 101, pattern extraction unit 103, reservation totaling unit 104, problem generation unit 105, solution unit 106, and output unit 107 of the seat reservation device 100. The electronic circuit 90 is connected to a signal line 91. The electronic circuit 90 is specifically a single circuit, a composite circuit, a programmed processor, a parallel-programmed processor, a logic IC, a GA, an ASIC, or an FPGA. Note that: GA stands for Gate Array; ASIC for Application Specific Integrated Circuit; and FPGA for Field-Programmable Gate Array. Features of feature constituent elements of the seat reservation device 100 may be implemented by one electronic circuit, or may be implemented by a plurality of electronic circuits by distribution. Some of the features of the feature constituent elements of the seat reservation device 100 may be implemented by an electronic circuit, and the remaining features may be implemented by software.

The CPU and the input accepting unit 101 are also called processing circuitry. The features of the input accepting unit 101, storage unit 102, pattern extraction unit 103, reservation totaling unit 104, problem generation unit 105, solution unit 106, and output unit 107 of the seat reservation device 100 may be implemented by processing circuitry.

### REFERENCE SIGNS LIST

90: electronic circuit; 91: signal line; 100: seat reservation device; 101: input accepting unit; 102: storage unit; 103: pattern extraction unit; 104: reservation totaling unit; 105: problem generation unit; 106: solution unit; 107: output unit; 110: processor; 120: main storage device; 130: auxiliary storage device; 131: seat reservation program; 140: input interface; 150: output interface; 160: communication interface; 170: signal line; 210: reservation information; 220: vehicle information; 230: evaluation index information; 240A: consecutive-seating pattern candidate group; 240B: consecutive-seating pattern group; 250: total information; 260: optimization problem; 270: seating layout; 300: input terminal; 400: output terminal; 1000: seat reservation system.

1. A seat reservation device comprising
processing circuitry
to extract, from a consecutive-seating pattern candidate group formed of a plurality of consecutive-seating patterns which are set per count of passenger-group people and arranged such that passengers of a same passenger group are consecutively seated,
a plurality of consecutive-seating patterns as a consecutive-seating pattern group, based on
reservation information which is information expressing a reservation for a target transportation facility and including a plurality of records each including a boarding section for the transportation facility and a same-time reservation people count being one unit of reservation people count, to make a reservation for a same operation schedule of the transportation facility, and
transportation facility information including a seat setting state of the transportation facility and a stop position at which the transportation facility of the same operation schedule stops;
to total counts of suites per suite type having a same boarding section and a same same-time reservation people count, from the reservation information, and to generate a total result as total information;
to generate an optimization problem on seating layout of reservation passengers, which involves a decision variable not dependent on a reservation people count, a constraint condition, and an objective function, based on the transportation facility information, an evaluation index designated as a guideline of the objective function, the consecutive-seating pattern group, and the total information;
to solve the optimization problem and to decide the seating layout of the reservation passengers; and
to output the seating layout.

2. The seat reservation device according to claim 1,
wherein the processing circuitry generates the decision variable that expresses whether there is seat allocation of a reservation passenger, by a unit of each consecutive-seating pattern of the consecutive-seating pattern group.

3. The seat reservation device according to claim 1,
wherein the processing circuitry generates an overlapping constraint which constrains each seat from being allocated to two or more reservations for the same boarding section, and a reservation count constraint indicating that a total allocatable count of reservations of suites each consisting of the boarding section and the same-time reservation people count is the same as a total value of the total information.

4. The seat reservation device according to claim 1,
wherein the passenger group is formed of one or more passengers,
wherein the consecutive-seating pattern candidate group involves a plurality of consecutive-seating patterns corresponding to the passenger group of 1-person,
wherein the reservation information includes a 1-person reservation record indicating 1-person reservation in which the same-time reservation people count is 1 and which includes a designation type of window-side designation, aisle-side designation, or no designation, and
wherein the processing circuitry
totals, regarding the 1-person reservation, counts of suites per suite type having a same designation type and the same boarding section, from the reservation information, and generates total information including a total result of the 1-person reservation, and
generates a constraint condition indicating that a total allocatable count for the 1-person reservation is the same as a sum total of a total value of the window-side designation in the total information, a total value of the aisle-side reservation in the total information, and a total value of the no designation in the total information, and a constraint condition indicating that an allocable count of consecutive-seating patterns corresponding to the window-side designation is not smaller than the total value of the window-side designation, and that an allocable count of consecutive-seating patterns corresponding to the aisle-side designation is not smaller than the total value of the aisle-side designation, based on the transportation facility information, the evaluation index, the consecutive-seating pattern group, and the total information.

5. The seat reservation device according to claim 1,
wherein the designated evaluation index is a distributed layout defining that the fewer the seats being from different reservations are adjacent, the better, and
wherein the processing circuitry generates an objective function that minimizes the seats which are from the different reservations and adjacent to each other, in accordance with the distributed layout of the evaluation index.

6. The seat reservation device according to claim 1,
wherein the designated evaluation index is vacant seat securement defining that the more vacant seats which form a bunch, the better, and
wherein the processing circuitry generates an objective function that secures vacant seats in a rear part of the transportation facility in the same operation schedule with respect to a traveling direction, for sections from a start point at which the transportation facility starts moving to an end point at which the transportation facility stops moving, in accordance with the vacant seat securement of the evaluation index, so as to reduce vacant seats in a forward part and to increase acceptable reservations.

7. A non-transitory computer readable medium recorded with a seat reservation program which causes a computer to execute:
a pattern extraction process of extracting, from a consecutive-seating pattern candidate group formed of a plurality of consecutive-seating patterns which are set per count of passenger-group people and arranged such that passengers of a same passenger group are consecutively seated,
a plurality of consecutive-seating patterns as a consecutive-seating pattern group, based on
reservation information which is information expressing a reservation for a target transportation facility and including a plurality of records each including a boarding section for the transportation facility and a same-time reservation people count being one unit of reservation people count, to make a reservation for a same operation schedule of the transportation facility, and
transportation facility information including a seat setting state of the transportation facility and a stop position at which the transportation facility of the same operation schedule stops;
a reservation totaling process of totaling counts of suites per suite type having a same boarding section and a same same-time reservation people count, from the reservation information, and generating a total result as total information;
a problem generation process of generating an optimization problem on seating layout of reservation passengers, which involves a decision variable not dependent on a reservation people count, a constraint condition, and an objective function, based on the transportation facility information, an evaluation index designated as a guideline of the objective function, the consecutive-seating pattern group, and the total information;
a solution process of solving the optimization problem and deciding the seating layout of the reservation passengers; and
an output process of outputting the seating layout.

8. A seat reservation method comprising:
extracting, from a consecutive-seating pattern candidate group formed of a plurality of consecutive-seating patterns which are set per count of passenger-group people and arranged such that passengers of a same passenger group are consecutively seated,
a plurality of consecutive-seating patterns as a consecutive-seating pattern group, based on
reservation information which is information expressing a reservation for a target transportation facility and including a plurality of records each including a boarding section for the transportation facility and a same-time reservation people count being one unit of reservation people count, to make a reservation for a same operation schedule of the transportation facility, and
transportation facility information including a seat setting state of the transportation facility and a stop position at which the transportation facility of the same operation schedule stops;
totaling counts of suites per suite type having a same boarding section and a same same-time reservation people count, from the reservation information, and generating a total result as total information;
generating an optimization problem on seating layout of reservation passengers, which involves a decision variable not dependent on a reservation people count, a constraint condition, and an objective function, based on the transportation facility information, an evaluation index designated as a guideline of the objective function, the consecutive-seating pattern group, and the total information;
solving the optimization problem and deciding the seating layout of the reservation passengers; and
outputting the seating layout.

9. A seat reservation system comprising an input terminal, a seat reservation device, and an output terminal,
wherein the input terminal inputs designation information which designates an evaluation index being a guideline of an objective function, to the seat reservation device,
wherein the reservation device comprises
processing circuitry
to extract, from a consecutive-seating pattern candidate group formed of a plurality of consecutive-seating patterns which are set per count of passenger-group people and arranged such that passengers of a same passenger group are consecutively seated,
a plurality of consecutive-seating patterns as a consecutive-seating pattern group, based on
reservation information which is information expressing a reservation for a target transportation facility and including a plurality of records each including a boarding section for the transportation facility and a same-time reservation people count being one unit of reservation people count, to make a reservation for the same operation schedule of the transportation facility, and
transportation facility information including a seat setting state of the transportation facility and a stop position at which the transportation facility of the same operation schedule stops;
to total counts of suites per suite type having the same boarding section and the same same-time reservation people count, from the reservation information, and to generate a total result as total information;
to generate an optimization problem on seating layout of reservation passengers, which involves a decision variable not dependent on a reservation people count, a constraint condition, and the objective function, based on the transportation facility information, the evaluation index, the consecutive-seating pattern group, and the total information;
to solve the optimization problem and to decide the seating layout of the reservation passengers; and
to output the seating layout, and
wherein the output terminal displays the seating layout.
